(19) United States
(12) Patent Application Publication
(10) Pub. No.: US 2006/0179158 A1
(43) Pub. Date: Aug. 10, 2006

(54) Router with synchronized updating of routing tables for a distributed routing communications network

(75) Inventors: Claire-Sabine Randriamasy, Meudon (FR); Jean-Pierre Rombeaut, Maubeuge (FR); Thomas Moore, Clichy (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/346,262

(22) Filed: Feb. 3, 2006

(30) Foreign Application Priority Data
Feb. 7, 2005 (FR) 0550349

(51) Int. Cl. G06F 15/173

(52) U.S. Cl. 709/238

(57) ABSTRACT

A router (R) for a distributed routing communications network includes i) a database (BD1-BD3) containing data representing states of links between routers of the network, ii) calculation means (MC) adapted to determine routes from the data and to update distributed routing tables as a function of the determined routes, and iii) management means (MG) adapted, in the event of local reception or transmission of an LSA or a TE-LSA at a time TAL(R), to determine the elapsed time (T_e) from the reception or transmission of the last instance of the LSA or the TE-LSA in order to compare it to a selected threshold and either to await the expiry of a current calculation delay (OPC) in the presence of a TE-LSA or to trigger a stabilization delay of selected duration and the starting time TAL(R) of which serves to resynchronize the expiry time of the current calculation delay to a selected time in the presence of a bursty TE-LSA, so as to instruct the calculation means (MC), after expiry of the calculation delay, to determine new routes from the last LSA or TE-Lsa instances received that were sent before a time preceding the expiry time of the current calculation delay by a time at least equal to a synchronization threshold and then to update the associated routing tables after expiry of a refresh delay.

The invention relates to distributed routing communications networks and more precisely to routers in such networks.

In the present context the expression “router” refers to a distributed routing equipment (or node) adapted to exchange with other routers of the network to which it belongs link state advertisements (LSA) including data representing the availability of a link or data representing the occupancy of a link, for example the bandwidth used or available, in which case they are known as traffic engineering-link state advertisements (TE-LSA).

To prevent deviation of traffic and/or formation of routing loops in distributed routing networks, it is important for the routing decisions taken by routers to be coherent. To this end, the routers of a distributed routing network must include routing databases containing data representing substantially identical inter-router link states, so that they have the same overview of the state of the network.

This is relatively easy if routing is based on static or quasi-static metrics, for example the number of hops, which are derived from the LSAs and constitute topological information that rarely changes. However, it is much more complicated if routing is based on dynamic metrics, for example the bandwidth (available, used or reserved) or the packet loss rate, which are typically derived from TE-LSAs and change regularly. This requires the routing databases to be synchronized and to have access to the most recent routing information.

The Intermediate System—Intermediate System (IS-IS) distributed routing protocol offers no mechanism for synchronizing databases with acknowledgement, including between adjacent routers. It is based on the assumption that if a change occurs at the level of an inter-router link, there is a high probability that the corresponding change of link state will propagate and be updated in the vicinity of the link concerned at the end of a certain time. Consequently, in the event of modification of the state of a link of an IS-IS protocol router, it must wait for a predetermined time Wdelay before recalculating the routes to update its routing tables.

The Open Shortest Path First (OSPF) distributed routing protocol guarantees synchronization of the databases of adjacent routers thanks to a database exchange process (DEP) mechanism. According to the DEP mechanism, routers are considered to be neighbours if they have exchanged their most recent LSAs. To be more precise, the routers must first exchange database description packets (DDP) which each contain a list of the LSAs it has available and their update dates and times. On receipt of a DDP, the router compares the update dates and times received to those stored in its database in corresponding relationship to the routing data of the LSAs to determine those that have to be updated. The router then sends the adjacent router, which sent it the DDP, a link state request including a list of the LSAs that it wishes to update. Finally, when the requesting router receives the requested LSAs, it updates its database and sends the sending router link state acknowledgement that terminates the DEP mechanism.

Link state modifications being liable to occur at any time and anywhere in the network, and the time of synchronization of the LSA databases of the routers by progressive broadcasting (known as flooding) being unpredictable within the network, the DEP mechanism cannot guarantee synchronization of the LSA database of a router with those of the routers of the network that are not its neighbours. Consequently, the synchronization of the LSA databases of the routers within a large network may never be obtained.

To improve upon this situation, it has been proposed to delay the updating of the databases by a predetermined delay spfDelay supposedly enabling the most recent LSAs to propagate, as in the situation with the IS-IS routing protocol. In this case, an OSPF protocol router can recalculate its routes only on the three-fold condition that it has received an LSA update, a delay equal to spfDelay has elapsed since receiving that LSA update, and it is actually synchronized with its neighbours.

However, this improvement is adapted only to routing based on topology-related LSAs, which do not change and are sent only irregularly. These LSAs can generally be identified as advertising a cascade of LSAs liable to arrive within the delay spfDelay.

Like the IS-IS distributed routing protocol, the OSPF distributed routing protocol therefore does not guarantee that the LSAs used by a router to update its routing tables are the same as those used by other routers of its network to update their respective routing tables.

The patent document FR 2843263 proposes an adaptive routing with multiple criteria (RMC) algorithm that calculates the optimum paths (or routes) according to a predetermined period spfHoldDelay and reports the link state changes by means of specific LSAs called TE-LSAs. However, an LS Age field in each TE-LSA is merely proportional to the number of hops and thus does not reflect accurately its sending time. Consequently, the algorithm does not guarantee that the TE-LSAs used by a router to update its routing tables are the same as those used by other routers of its network to update their respective routing tables.

Thus an object of the invention is to improve on the situation of there being no entirely satisfactory distributed routing protocol.

To this end, the invention proposes a router for a distributed routing communications network, the router including a database containing data representing states of links between routers of the network and calculation means able to determine routes from that data and to update distributed routing tables as a function of the determined routes.

The router is characterized in that it includes management means adapted, if they receive or send at a time TAL(R) data representing the state of a link:

to determine the elapsed time from the reception or transmission of the last instance of the data representing the state of the link; and then

to compare that elapsed time to a selected threshold; and

either to await the expiry of a current calculation delay of predefined duration if the elapsed time is below the selected threshold and if the data representing the state of the link is of TE-LSA type (a regular TE-LSA) or to trigger a stabilization delay of selected duration and the starting time TAL(R) of which serves to resynchronize the expiry time of the current calculation delay to a selected time if the elapsed time is greater than or equal to the selected threshold (a bursty TE-LSA) and/or if the data representing the state of the link is of LSA type, so as to instruct the calculation means, after expiry of said calculation delay, to determine new routes from the last instances of the received data representing states of inter-router links that were sent before a time preceding the expiry time of the current calculation delay by a time at least equal to a synchronization threshold and then to update the associated routing tables after expiry of a refresh delay.

The router of the invention may have other features and in particular, separately or in combination:

its management means may be adapted to manage the addition to the data representing the state of a link intended to be sent to the other routers of a time mark representing their sending time and, where appropriate, a time mark representing the next expiry time of the calculation delay;

the management means may be adapted, in the event of reception of an LSA, to compare the triggering time of the current stabilization delay of their router, which is stored in a memory, to the sending time of said LSA in order to resynchronize their current stabilization delay to the time of sending the LSA and therefore the expiry time of the current calculation delay of their router if the triggering time is after the sending time of the LSA;

the management means may be adapted to compare the triggering time of the current stabilization delay to the sending time of an LSA if the LSA was received during the current stabilization delay;

its management means may be adapted, in the presence a bursty TE-LSA or an LSA and on expiry of said stabilization delay, to trigger a synchronization delay of duration equal to the selected synchronization threshold and expiring at the same time as the calculation delay;

its management means may be adapted, in the event, of long-term instability or instability necessitating a general reset at the level of a managed topology domain, to instruct the sending to the other routers of the network of a delay synchronization message in order for them to use the resynchronized calculation delay in a substantially synchronized manner;

the synchronization message may include information representing the next expiry time of the calculation delay;

the synchronization message is for example an opaque LSA including a protocol number corresponding to a Distributed Dynamic Traffic Engineering (DDTE) type in the identification field;

The invention also proposes a method of updating distributed routing data for a distributed routing communications network including a multiplicity of routers.

The method is characterized in that, when a router receives or sends data representing the state of a link, it consists in, at a time TAL(R):

determining an elapsed time from the reception or the sending of the last instance of the data representing the state of the link; then

comparing that elapsed time to a selected threshold; and

either awaiting the expiry of a current calculation delay of predefined duration if the elapsed time is less than the selected threshold and if the data representing the state of the link is of TE_LSA type (regular TE_LSA) or triggering a stabilization delay of selected duration and the starting time TAL(R) of which serves to resynchronize the expiry time of the current calculation delay to a selected time if the elapsed time is greater than or equal to the selected threshold (bursty TE_LSA) and/or if the data representing the state of the link is of LSA type so as to instruct the calculation means, after expiry of the calculation delay, to determine new routes from the last instances of the data received, representing the states of the inter-router links and sent before a time preceding the expiry time of the current calculation delay by a time at least equal to a synchronization threshold, and then to update the associated routing tables after expiry of a refresh delay.

The invention is particularly well adapted to Internet Protocol (IP) communications networks.

Other features and advantages of the invention become apparent on reading the following detailed description and examining the appended drawings, in which:

FIG. 1 is a very diagrammatic representation of a portion of a communications network including seven routers of the invention connected to each other;

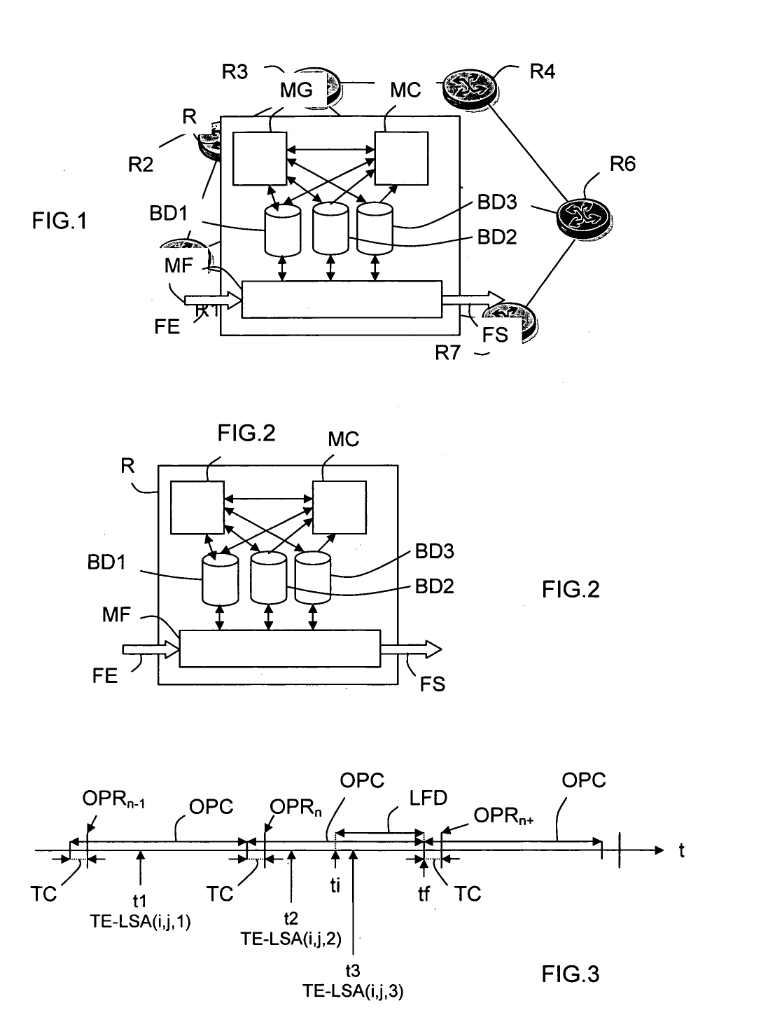

FIG. 2 is a very diagrammatic functional representation of a router of the invention;

FIG. 3 is a timing diagram showing a mechanism for updating routing tables in a router of the invention in the presence of regular TE-LSAs;

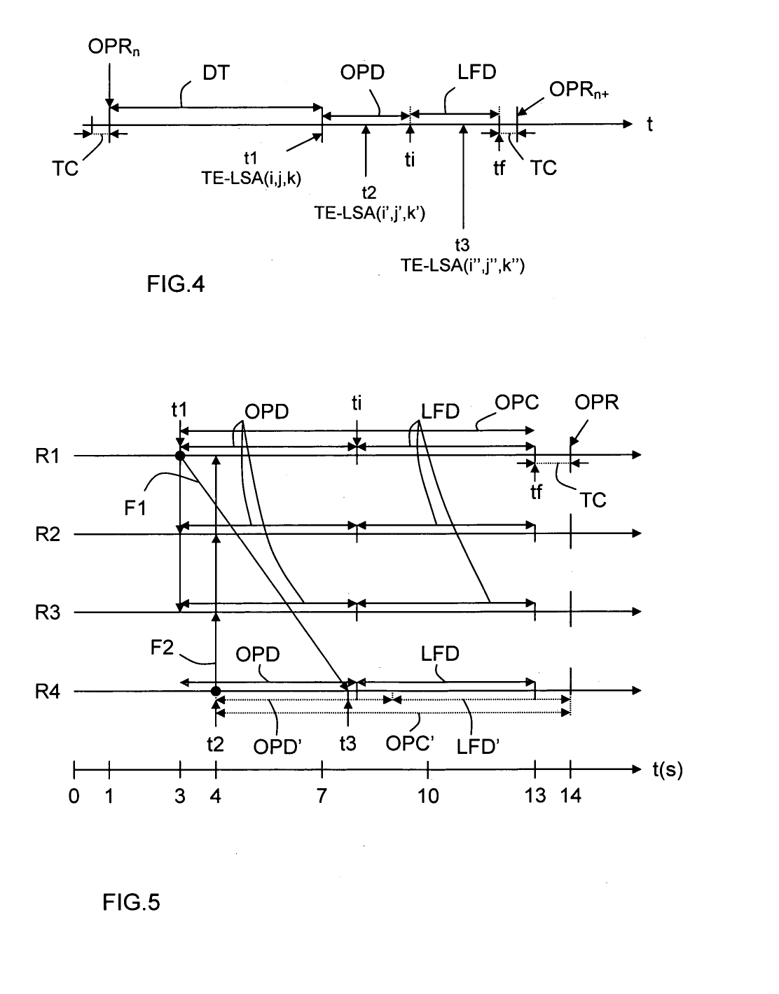

FIG. 4 is a timing diagram showing a mechanism for updating routing tables in a router of the invention in the presence of bursty TE-LSAs or LSAs;

FIG. 5 is a timing diagram showing the mechanisms for synchronizing databases and updating routing tables of four routers of the invention in the presence of bursty TE-LSAs or LSAs.

The appended drawings constitute part of the description of the invention and may, if necessary, contribute to the definition of the invention.

The invention relates to communications networks using a distributed routing protocol supporting Traffic Engineering—Link State Advertisement (TE-LSA) traffic management, for example the Open Shortest Path First—Traffic Engineering (OSPF-TE) link state routing protocol or the Intermediate System—Intermediate System—Traffic Engineering (IS-IS-TE) protocol.

The communications network considered hereinafter by way of non-limiting example is an Internet Protocol (IP) network.

As shown diagrammatically in FIG. 1, an IP network generally includes a multiplicity of routers or nodes Ri (here i=1 to 7, but may take any value greater than or equal to 2), connected to each other by links, and certain of which may be connected to local sub-networks of communications terminals or business terminals (not shown) or sometimes to isolated terminals.

The routers (or nodes) Ri of the IP network are all capable of exchanging between them link state advertisements including data representing the availability of a link or data representing the occupancy of a link, for example the bandwidth used or available, taking the form of traffic engineering LSAs (TE-LSAs).

As shown diagrammatically and functionally in FIG. 2, each router R includes a routing module (also called a route calculation module) MC and a transmission (also called a forwarding module) module MF coupled to its interfaces (not shown).

It further includes storage means BD1 that generally take the form of two routing databases, which may be separate, known as the routing information base (RIB) and the forwarding information base (FIB).

The routing information base stores routing data (or information) for routing IP datagrams (or data packets) to a subsequent router. As will emerge later, this routing data is determined (or calculated) by the routing module MC from data contained in LSAs or TE-LSAs received via the input interfaces of the router R (arrow FE) from other routers of the network in accordance with the database exchange process (DEP) mechanism. The data of the LSAs and the TE-LSAs is generally stored in two other databases BD2 and BD3.

The management module MG also manages sending of the LSAs or TE-LSAs intended for other LSA routers of the network via the output interfaces using the DEP mechanism (arrow FS). Here the management task relates to decisions to send TE-LSAs and decisions to insert into the LSAs and TE-LSAs to be sent a time stamp representing their sending time.

The routing module MC uses data contained in the LSA database BD2 and the TE-LSA database BD3 to calculate the routes.

The forwarding information base (FIB) stores routing data (or information) enabling the forwarding module MF to route IP datagrams (or data packets) to a subsequent router. This data essentially represents (re)transmission information extracted from the router information base.

The routing data (or information) stored in the storage means BD1 constitutes what are usually referred to as the routing tables of the router R.

As mentioned above, the routing (or route calculation) module MC determines routes from data that is stored in the storage means (essentially BD2 and BD3). It also updates the distributed routing tables stored in the storage means BD1 as a function of the routes that it determines.

Routes may be calculated by any algorithm known to the person skilled in the art and in particular the adaptive routing with multiple criteria (RMC) algorithm, with or without (local and/or global) constraints, which is described in particular in the patent document FR 2843263, the technical content of which is hereby incorporated herein by reference.

Depending on the variant concerned, the routing module MC is adapted to perform either best effort routing or quality of service (QoS) routing. Best effort routing is a basic form of routing that is characterized by taking account of criteria in the absence of constraints, whereas QoS routing is characterized by taking account of criteria in the presence of local and/or global constraints.

The invention relates more particularly to updating and synchronizing the routing tables and thus the storage means BD1 to BD3 of the routers Ri of the network, to avoid deviation of traffic and/or formation of routing loops, as much as possible.

To this end it proposes to equip the routers Ri of the network with a management module MG described hereinafter.

The management module MG intervenes each time that the router R in which it is installed receives or sends data representing the state of a link in the form of a TE-LSA or LSA instance, at a time TAL(R). A TE-LSA or LSA relates to a link (i,j) between two routers Ri and Rj and a TE-LSA or LSA instance carries an index (or identifier) k that represents its sending number from the creation of the link (i,j) and its sending time. In other words, a TE-LSA or LSA instance is characterized by a triplet (i,j,k) and a TE-LSA instance (i,j,k+1) constitutes the updated form of the preceding TE-LSA instance (i,j,k).

The management module MG is alerted to the reception or sending of a TE-LSA or LSA instance in its router R by the forwarding module MF that receives it.

Once the management module MG has been alerted to the reception or sending of a TE-LSA or LSA instance (i,j,k) at the time TAL(R), it determines the time T_e that has elapsed between that time TAL(R) and the time of receiving or sending the last TE-LSA or LSA instance (i,j,k−1).

It then compares that elapsed time T_e to a selected threshold SHT, which is equal to the time interval spfHoldTime between two prior art optimum path (or route) calculations, for example multiplied by a value k (with k=1, for example), that is to say SHT=k×spfHoldTime. The threshold SHT may be equal to 10 seconds, for example.

The further processing effected by the management module MG depends on the result of the comparison. Two situations must be envisaged.

FIG. 3 shows the first situation, which corresponds to an elapsed time T_e below the selected threshold SHT and to data representing the link state of TE-LSA type. In this case it is appropriate to refer to a “regular” TE-LSA.

In this first situation, the management module MG waits for the expiry (at time tf) of a calculation delay OPC that is in progress and the duration of which is predefined (or fixed) to trigger a refresh delay TC that is also of predefined (or fixed) duration and that corresponds to the time available to the routing module MC for calculating new routes.

By definition, in this first situation the calculation delay OPC has a duration equal to the time interval [OPRₙ₋₁; OPRₙ] between two successive updatings of the routing table stored in the storage means BD1 of the router R. However, each calculation delay OPC begins at the time (tf) of triggering the refresh delay TC (during which the routing module MC calculates the new routes) and ends at the time (tf+OPC) of triggering the next refresh delay TC. Moreover, each update time OPRₙ is synchronized to the expiry of the refresh delay TC.

It is important to note that this calculation delay OPC is not triggered by an event such as receiving or sending a regular TE-LSA. It is triggered automatically and periodically and it is the intervention of the management module MG that is triggered by an event such as receiving or sending a regular TE-LSA.

The management module MG is also operative at the expiry time tf of each calculation delay OPC to select from the received TE-LSAs and LSAs those that were sent at least tf—ti seconds before. The duration of each time interval tf—ti is equal to a “synchronization” threshold LFD.

The duration of the threshold LFD is chosen as a function of the arrangement of the network. To be more precise, it is selected to maximize the probability that all the routers Ri of the network will have received the last TE-LSA or LSA instance relating to each link (i,j) of said network. It is equal to approximately 5 seconds, for example. Consequently, each time that the Calculation delay OPC expires (at time tf) the routing module MC uses the last LSA and TE-LSA instances sent at least LFD seconds before.

In the example shown in FIG. 3, it may be seen that a first TE-LSA instance (i,j,l) is received by the router R before the last updating (OPRₙ) of its routing tables, that a second TE-LSA instance (i,j,2) is received by the router R after the first updating (OPRₙ) of the routing tables but before the time ti, and that a third TE-LSA instance (i,j,3) is received by the router R during the synchronization delay LFD. Consequently, if the TE-LSA (i,j,3) was sent before ti (and is therefore older than LFD), then it is taken into account; otherwise it is the TE-LSA (i,j,2) that is taken into account.

At the end of the refreshment delay TC, the management module MG instructs the routing module MC to update the associated routing tables taking account of the new routes that it has calculated.

It is important to note that in the first situation (which relates to regular TE-LSAs) the triggering and expiry times of the delays OPC and LFD used in the various routers Ri of the network are predefined. Consequently, synchronization of the updates (OPR) of the routing tables stored in the storage means BD1 of the various routers Ri of the network is automatic provided that the internal clocks of said routers Ri are synchronized by standard protocols, such as the Network Time Protocol (NTP) or the Simple Network Time Protocol (SNTP).

FIGS. 4 and 5 show the second situation, which corresponds to an elapsed time T_e greater than or equal to the selected threshold SHT and/or to data representing the link state of LSA type. If the data takes the form of a TE-LSA and the elapsed time T_e is greater than or equal to the selected threshold SHT, the TE-LSA is called “bursty”. Generally speaking, every LSA or TE-LSA containing information reflecting an alarming link state is here classified as bursty.

In the second situation, the management module MG also waits for the expiry (tf) of a calculation delay OPC to trigger the TC refresh delay (see above). However, in contrast to the first situation (relating to regular TE-LSAs), in which the calculation delay OPC was triggered at predefined times and its duration was fixed, in the second situation the expiry time of the calculation delay OPC may be changed if certain events occur. To be more precise, in this second situation the expiry time of the calculation delay OPC is changed by a management module MG when its router R has received or sent a bursty TE-LSA or an LSA and the sending time whereof satisfies a time condition explained hereinafter.

Each time that the management module MG is alerted to the sending or receiving of a first bursty TE-LSA or a first LSA (of a cascade of LSAs or TE-LSAs), it immediately triggers a stabilization delay OPD of selected duration and on the basis of which the new expiry time (tf) of the calculation delay OPC is fixed. Here, “first” refers to the bursty LSA or TE-LSA that has the earliest sending time.

The duration of the stabilization delay OPD is selected to enable stabilization of the states of all the network links (i,j) when an event has affected the state of one of said network links (i,j). It is typically of the order of about 5 seconds. It is important to note that it may be modified for the whole of the network if necessary.

It is important to note that most implementations of the OSPF protocol necessitate a router that has just received an LSA to wait for a time spdelay, starting from a reception time before updating its routing databases, whereas in accordance with the invention, when a router R receives or sends at a time TAL(R) an LSA or a bursty TE-LSA it temporarily locks the start of a stabilization delay OPD to the reception or sending time TAL(R), the stabilization delay OPD being definitively timed thereafter relative to the earliest sending time of the LSAs or TE-LSAs received by said router R during its stabilization delay OPD.

The expiry time (tf) of the calculation delay OPC is determined by adding to the definitive stabilization delay OPD (which expires at the time ti) a time period equal to a synchronization threshold LFD. This may equally be considered as a synchronization delay LFD whose start time ti coincides with the end of the definitive stabilization delay OPD, the end time tf of which coincides with the expiry time of the calculation delay OPC, and the duration of which is predefined (or fixed).

The duration of the synchronization threshold LFD is selected as a function of the arrangement of the network. To be more precise, it is selected to maximize the probability that all the routers Ri of the network will have received the last TE-LSA or LSA instance relating to each link (i,j) of said network. It is equal to approximately 5 seconds, for example.

At the end time (tf) of the synchronization delay LFD, and therefore of the calculation delay OPC, the management module MG triggers the refresh delay TC and, at substantially the same time, instructs the routing module MC to calculate new routes from the latest TE-LSA or LSA instances received relating to each network link (i,j) that were sent before the time ti representing the start of the synchronization delay LFD.

In this (non-limiting) embodiment, to determine the received bursty TE-LSA or LSA instances that the routing module MC must take into account, the management module JG uses the synchronization delay LFD, which it triggers at the time ti that marks the end of the stabilization delay OPD and expires at the same time as the calculation delay OPC. Accordingly, the last TE-LSA or LSA instance is considered to be the instance sent before the time ti marking the end of the stabilization delay OPD (and the beginning of the synchronization delay LFD).

In the FIG. 4 example, note that:

a bursty first TE-LSA (i,j,k) is received by the router R at the time t1 that is separated from the last updating (OPRₙ) of its routing table BD1 by a time period DT greater than the threshold SHT and which constitutes the start of the stabilization delay OPD;

a second TE-LSA (i′,j′,k′) is received by the router R at the time t2 during the stabilization delay OPD; and

a third TE-LSA (i″,j″,k″) is received by the router R during the synchronization delay LFD.

In the present example, the TE-LSA (i,j,k) and the TE-SA (i′,j′,k′) are taken into account whereas the TE-LSA (i″,j″,k″) is taken into-account only it was sent before the start of the synchronization delay LFD.

At the end of the refresh delay TC, the management module MG instructs the routing module MC to update the associated routing table stored in the storage means BD1 taking account of the new routes that it has calculated.

In this second case, which concerns LSAs and bursty TE-LSAs, the triggering time of the stabilization delay OPD used in the various routers Ri of the network is not known. Updating the associated routing table stored in the storage means BD1 of the various routers Ri of the network is synchronized automatically. As indicated above, the start of the stabilization delay OPD corresponds to the earliest sending time t* of the LSAs and bursty TE-LSAs received or sent between the triggering time t1 of the stabilization delay OPD and the expiry time ti (=t1+OPD) of the stabilization delay OPD. The expiry time ti of the next calculation delay OPC, common to all the routers of the topology domain concerned, is then equal to t*+OPD+LFD.

To effect this synchronization in the event of long-term instability or of instability necessitating a general reset at the level of a managed topology domain, it is advantageous if the management module MG which triggered a stabilization delay OPD following the reception or sending of a bursty TE-LSA or a bursty LSA generates a delay synchronization message MS sent to the other routers of its topology domain.

The delay synchronization message MS is intended to allow the other routers of a topology domain to synchronize their calculation delays OPC to that triggered by the management module MG of the router R that sent them said message MS, in order for them to be able to update their respective routing tables in a substantially synchronized manner.

To enable synchronization, each synchronization message MS includes, for example, information representing the triggering time of the calculation delay OPC, which is common to all the routers of the topology domain. Each synchronization message MS may equally include data representing the selected duration of the stabilization delay OPD, or other variables such as TC or LFD, in particular if the variables vary in time or represent the start of the next link occupancy measurement.

The synchronization messages MS may be opaque LSAs, for example. Their identification field may include an opaque field (typically equal to 1 for TE-LSAs) and a field identifying and representing their specific type, for example distributed dynamic traffic engineering (DDTE). The opaque LSAs are classed as of type 10 because they relate to their topology domain.

The management module MG deduces the time tf at which the calculation delay OPC should expire from the known triggering time of the stabilization delay OPD. If the synchronization message MS contains data representing the expiry time tf of the calculation delay OPC (or the updating time OPR of the routing tables stored in the storage means BD1), the management module MG has no deduction to perform. It extracts the expiry time tf or the update time OPR directly from the message.

At the end of the calculation delay OPC the management module MG triggers the refresh delay TC. At substantially the same time as it triggers the refresh delay TC, the management module MG instructs the router module MC to calculate new routes from the last TE-LSA and LSA instances received relating to each network link (i,j) and the sending time whereof is before the expiry time tf of the calculation delay OPC minus the synchronization delay LFD. Then, at the end of the refresh delay TC, the management module MG instructs the routing module MC to update the routing table stored in the storage means BD1, given the new routes it has calculated.

In the second case, which relates to LSAs and to bursty TE-LSAs, it may happen that a router triggers a stabilization delay OPD just after another router has triggered a calculation delay OPC. FIG. 5 shows this kind of situation.

In the example shown, the router R1 sends the routers R2 to R4 at time t1=3 seconds a bursty TE-LSA or an LSA to report a link state modification to them and the router R4 sends the routers R1 to R3 at the time t1=4 seconds a bursty TE-LSA or an LSA to report a link state modification to them.

When the router R1 advises its management-module MG that at the time t1=3 seconds its sent a bursty TE-LSA or an LSA, said management module MG triggers its stabilization delay OPD at that time t1. When the stabilization delay OPD expires (at time t1=8 seconds) the management module MG of the router R1 takes the synchronization delay LFD, which here expires at the time tf=13 seconds, into account when defining tf as the expiry time of its calculation delay OPC.

In this example, only the routers R2 and R3 receive the bursty TE-LSA (or the LSA) sent by the router R1 a few milliseconds after t1=3 seconds, which constitutes for each of them an event triggering their stabilization delay OPD.

When the router R4 advises its management module MG that it sent a bursty TE-LSA or an LSA at the time t2=4 seconds, it starts it temporary stabilization delay OPD′ at that time t2. When its stabilization delay OPD′ expires (at the time ti′=9 seconds) the management module MG of the router R4 should take the synchronization delay LFD, which should end at the time tf′=14 seconds, into account when defining tf′ as the expiry time of its calculation delay OPC′.

Two stabilization delays OPD and OPD′ coexist with a time difference of 1 second.

In this example, the routers R1 to R3 triggered their respective stabilization delays OPD at substantially the same time (t1=3 seconds). During their stabilization delay OPD they receive only the bursty TE-LSA or the LSA sent by the router R4 at the time t2=4 seconds. The time t2 being after the triggering time t1 of their stabilization delays OPD, the latter delays are therefore synchronized and definitive. The routers R1 to R3 can then determine the expiry time tf of their common calculation delay OPC (here tf=13 seconds), and thus the time (OPR=tf+TC) at which they will be able to update their routing tables stored in their storage means BD1 (OPR=14 seconds if the route calculation phase TC lasts 1 second).

The router R4 receives the bursty TE-LSA or the LSA sent by the router R1 only at around the time t3=7.5 seconds, after one or two retransmissions (arrow F1). When its management module MG is advised of the reception by its router R4 of that bursty TE-LSA or LSA, it compares its sending time (here t1=3 seconds) to the triggering time of its stabilization delay OPD′ (here t2=4 seconds). The time t2 being after the time t1 and the router R4 not having received any other LSA or bursty TE-LSA during its stabilization delay OPD′, the management module MG of the router R4 immediately deduces that it must retime the start of its stabilization delay OPD′ from the time t1 that is the start of the stabilization delay OPD common to the routers of its topology domain. This retiming of the stabilization delay of the router R4 causes retiming of the expiry time of its current calculation delay OPC. All the routers R1 to R4 of the topology domain are then synchronized automatically.

This way of synchronizing the routers belonging to the same topology domain to a common stabilization delay OPD and a common calculation delay OPC prevents the occurrence of explicit permanent resynchronizations that are very closely spaced in time, which could prevent certain updates of routing tables (BD1).

In either situation, in the event of strong interference affecting the network, corresponding to a sufficiently extended and/or sufficiently long unavailability reflected in an absence of reception of TE-LSA or LSA, it is advantageous to reset the delays of all the routers Ri of the network, as described above.

The management module MG and the routing module MC of a router R of the invention may take the form of electronic circuits, software (or electronic data processing) modules, or a combination of circuits and software.

The invention is not limited to the router embodiments described hereinabove by way of example only, and encompasses all variants that the person skilled in the art might envisage that fall within the scope of the following claims.

1. A router (R) for a distributed routing communications network, said router including a database (BD1-BD3) containing data representing states of links between routers of said network and calculation means (MC) adapted to determine routes from said data and to update distributed routing tables as a function of said determined routes, characterized in that it further includes management means (MG) adapted, in the event of local reception or transmission at a time TAL(R) of data representing the state of a link, to determine an elapsed time (T_e) from the reception or transmission of the last instance of the data representing the state of said link and then to compare that elapsed time (T_e) to a selected threshold (SHT) and either to await the expiry of a current calculation delay (OPC) of predefined duration if said elapsed time (T_e) is below said selected threshold (SHT) and if said data representing the state of said link is of TE-LSA type or to trigger a stabilization delay (OPD) of selected duration and the starting time TAL(R) of which serves to resynchronize the expiry time of said current calculation delay (OPC) to a selected time if said elapsed time (T_e) is greater than or equal to the selected threshold (SHT) and/or if said data representing the state of said link is of LSA type, so as to instruct said calculation means (MC), after expiry of said calculation delay (OPC), to determine new routes from the last instances of the received data representing states of inter-router links sent before a time preceding said expiry time of the current calculation delay (OPC) by a time at least equal to a synchronization threshold (LFD) and then to update the associated routing tables after expiry of a refresh delay (TC).

2. A router according to claim 1, characterized in that said management means (MG) are adapted, in the presence of an elapsed time greater than or equal to said selected threshold (SHT) and/or of data representing the state of a link of LSA type, to manage the addition to the data representing the state of a link intended to be sent to the other routers of a time mark representing its sending time.

3. A router according to claim 2, characterized in that said management means (MG) are adapted to manage the addition to the data representing the state of a link intended to be sent to the other routers of a time mark representing the next expiry time of said calculation delay (OPC).

4. A router according to claim 2, characterized in that said management means (MG) are adapted, in the event of reception of an LSA, to compare the triggering time of their current stabilization delay (OPD), which are stored in a memory, to the sending time of said LSA in order to resynchronize their current stabilization delay (OPD) to the sending time of said LSA and therefore the expiry time of their current calculation delay (OPC) if said triggering time is after the sending time of said LSA.

5. A router according to claim 4, characterized in that said management means (MG) are adapted to compare said triggering time of their current stabilization delay (OPD) to said sending time of an LSA if the LSA was received during the current stabilization delay (OPD).

6. A router according to claim 1, characterized in that said management means (MG) are adapted, in the presence of an elapsed time greater than or equal to said selected threshold (SHT) and/or of data representing the state of a link of LSA type and on expiry of said stabilization delay (OPD), to trigger a synchronization delay (LFD) of duration equal to said selected synchronization threshold (LFD) and expiring at the same time as said calculation delay (OPC).

7. A router according to claim 1, characterized in that said management means (MG) are adapted, in the event of long-term instability or instability necessitating a general reset at the level of a managed topology domain, to instruct the sending to the other routers of the network of a delay synchronization message in order for them to use the resynchronized calculation delay (OPC) in a substantially synchronized manner.

8. A router according to claim 7, characterized in that said synchronization message includes information representing the next expiry time of said calculation delay (OPC).

9. A router according to claim 7, characterized in that said synchronization message is an opaque LSA including a protocol number corresponding to a DDTE type in an identification field.

10. A router according to claim 1, characterized in that said management means (MG) are adapted, in the event of absence of reception of data representing the state of a link for a time period greater than a selected unavailability threshold, to generate, for sending to the other routers of said network, a reset message including data representing the triggering time of the next calculation delay (OPC) to be triggered so that they use said calculation delay (OPC) in a substantially synchronized manner.

11. A method of updating distributed routing data for a distributed routing communications network including a multiplicity of routers (R) each including a database (BD1-BD3) containing data representing states of inter-router links and calculation means (MC) adapted to determine routes from said data and to update routing tables as a function of said determined routes, characterized in that, when a router (R) receives or sends data representing the state of a link, it consists in, at a time TAL(R):
determining an elapsed time (T_e) from the reception or the sending of the last instance of the data representing the state of said link; then
comparing that elapsed time to a selected threshold (SHT); and
either awaiting the expiry of a current calculation delay (OPC) of predefined duration if said elapsed time (T_e) is less than said selected threshold and if said data representing the state of said link is of TE_LSA type or triggering a stabilization delay (OPD) of selected duration and the starting time TAL(R) of which serves to resynchronize the expiry time of said current calculation delay (OPC) to a selected time if said elapsed time (T_e) is greater than or equal to said selected threshold (SHT) and/or if said data representing the state of said link is of LSA type so as to instruct said calculation means (MC), after expiry of the calculation delay (OPC), to determine new routes from the last instances of the data received, representing the states of the inter-router links and sent before a time preceding said expiry time of the current calculation delay (OPC) by a time at least equal to a synchronization threshold (LFD), and then to update the associated routing tables after expiry of a refresh delay (TC).
